(19) United States
(12) Patent Application Publication
(10) Pub. No.: US 2022/0105482 A1
(43) Pub. Date: Apr. 7, 2022

(54) MULTI-MATERIAL DISPENSING SYSTEM HAVING A QUICK-CONNECT FLUID DISPENSER THAT RELEASABLY COUPLES TO A PUMP HOUSING

(71) Applicant: NORDSON CORPORATION, WESTLAKE, OH (US)

(72) Inventor: Stephen R. des Jardins, Encinitas, CA (US)

(21) Appl. No.: 17/424,932

(22) PCT Filed: Jan. 22, 2020
(86) PCT No.: PCT/US2020/014545

§ 371 Date: Jul. 22, 2021

Related U.S. Application Data
(60) Provisional application No. 62/796,090, filed on Jan. 24, 2019.

(51) Int. Cl. B01F 25/60; B05C 11/10; B05C 9/06; B05C 5/02; B05B 15/65; B05C 17/005

(52) U.S. Cl. CPC B01F 25/60; B05C 11/1036; B05C 9/06; B01F 2101/2305; B05B 15/65; B05C 17/00506; B05C 17/00553; B05C 5/0225

(57) ABSTRACT

In one example, a dispensing system has a housing that supports a first and second pumps. The housing defines a receptacle and first and second passages. The receptacle defines at least one hole that extends into the housing that can receive a plug of a fluid dispenser. The first passage extends from the at least one hole to a first pump outlet, such that the first passage can communicate a first fluid material from the first pump outlet to the fluid dispenser. The second passage extends from the at least one hole to a second pump outlet, such that the second passage can communicate a second fluid material from the second pump outlet to the fluid dispenser. The system has an engagement feature that can engage a corresponding feature of the plug of the fluid dispenser so as to releasably secure the fluid dispenser to the housing.

### CROSS REFERENCE TO RELATED APPLICATIONS

This application is a National Stage Application of International Patent App. No. PCT/US2020/014545, filed Jan. 22, 2020, which claims the benefit of U.S. Provisional Patent App. No. 62/796,090, filed Jan. 24, 2019, the entire disclosures of both of which are hereby incorporated by reference as if set forth in their entirety herein.

### TECHNICAL FIELD

This disclosure generally relates to two-component mixing and dispensing systems, and more particularly to two-component mixing and dispensing systems utilizing a modular manifold that can be removed for easy cleaning.

### BACKGROUND

Multi-part or multi-component materials depend on a mixing action to start a cure reaction. Conventional static mixers include baffles for mixing the components. Curing may start as soon as the components first contact one another. Current mixing tip designs allow for the components to contact at the entrance of the static mixer. Although static mixers are designed to be easily changed and disposable, the entrance of the static mixer can be a source of possible contamination in a precision dispense environment. As such, unless the equipment components upstream of the contaminating contact point are cleaned when the static mixer is replaced, there is potential for change in, or loss of, performance and loss of customer parts. Current solutions require tooled disassembly of the dispensing component for cleaning. Such disassembly is a time-consuming process that interrupts production and wastes material during cleaning and setup.

### SUMMARY

In an example, a fluid material dispensing system, comprises a housing and an engagement feature. The housing is configured to support at least a portion of each of a first pump and a second pump. The housing defines a receptacle that defines at least one hole that extends into the housing that is configured to receive a projection of a plug of a fluid dispenser. The housing defines a first passage that extends from the at least one hole to a first pump outlet of the first pump when the first pump is supported by the housing, such that the first passage is configured to communicate a first fluid material from the first pump outlet to the fluid dispenser when the fluid dispenser is coupled to the housing. The housing defines a second passage that extends from the at least one hole to a second pump outlet of the second pump when the second pump is supported by the housing, such that the second passage is configured to communicate a second fluid material from the second pump outlet to the fluid dispenser when the fluid dispenser is coupled to the housing. The engagement feature is configured to engage a corresponding engagement feature of the plug of the fluid dispenser when the plug is received in the receptacle so as to releasably secure the fluid dispenser to the housing.

In another example, a fluid dispenser for a material dispensing system comprises a dispensing body and a plug. The dispensing body has a first end and a second end that are offset from one another. The second end comprises at least one nozzle configured to dispense first and second fluid materials. The plug is attached to the first end of the dispensing body and configured to be received in a receptacle of a housing that supports first and second pumps of the fluid material dispensing system. The plug comprises at least one outer surface that defines first and second openings, and at least one projection that extends from the at least one outer surface. The projection is configured to be received in a hole of the receptacle and defines an engagement feature that is configured to engage a corresponding engagement feature of the housing. The fluid dispenser defines 1) a first fluid passage that extends from the first opening towards the at least one nozzle, the first fluid passage being configured to direct a first fluid material from the first pump towards the at least one nozzle, and 2) a second fluid passage that extends from the second opening towards the at least one nozzle, the second fluid passage being configured to direct a second fluid material from the second pump towards the at least one nozzle.

In yet another example, a method of assembling a fluid material dispensing system comprises a step of aligning a plug of a fluid dispenser with a receptacle of a housing. The housing is configured to support first and second pumps of the fluid material dispensing system. The method comprises a step of inserting the plug in the receptacle such that first and second fluid passages of the fluid dispenser are in fluid communication with first and second fluid passages of the housing, respectively, and such that 1) the first fluid passages of the fluid dispenser and the housing are in fluid communication with one another and configured to direct a first fluid material from the first pump to at least one nozzle of the fluid dispenser, and 2) the second fluid passages of the fluid dispenser and the housing are in fluid communication with one another and configured to direct a second fluid material from the second pump to the at least one nozzle. The method comprises a step of actuating a fastener so as to move an engagement feature of at least one of the fluid dispenser and the housing into engagement with an engagement feature of the other of the at least one of the fluid dispenser and the housing so as to releasably secure the fluid dispenser to the housing.

### BRIEF DESCRIPTION OF THE DRAWINGS

The following description of the illustrative examples may be better understood when read in conjunction with the appended drawings. It is understood that potential examples of the disclosed systems and methods are not limited to those depicted.

FIG. 1 shows a perspective view of a dispensing system according to one example having a fluid dispenser received in a housing of the system;

FIG. 2 shows a perspective view of the dispensing system of FIG. 1 with the fluid dispenser removed from the housing;

FIG. 3 shows a perspective view of the housing of the dispensing system of FIG. 1 that includes a proximal end of the housing;

FIG. 4 shows a perspective view of the housing of the dispensing system of FIG. 1 that includes a distal end of the housing;

FIG. 5 shows a cross-sectional view of a portion of the dispensing system of FIG. 1 taken along a plane that bisects the housing approximately midway between a front side and a back side of the housing, where the fluid dispenser comprises a mixer;

FIG. 6 shows a first perspective view of the fluid dispenser of the dispensing system of FIG. 1, where the fluid dispenser comprises a mixer;

FIG. 7 shows an exploded perspective view of the fluid dispenser of FIG. 6;

FIG. 8 shows another perspective view of the fluid dispenser of FIG. 6;

FIG. 9 shows a cross-sectional view of a portion of the dispensing system of FIG. 1 taken along a plane that bisects the housing midway between a first lateral side and a second lateral side of the housing;

FIG. 10 shows an assembled perspective view of a fastener of the dispensing system of FIG. 1 that is configured to secure the fluid dispenser to the housing;

FIG. 11 shows an exploded perspective view of the fastener of FIG. 10;

FIG. 12 shows a perspective view of a dispensing system according to another example having a fluid dispenser received in a housing of the system;

FIG. 13 shows a perspective view of the dispensing system of FIG. 12 with the fluid dispenser removed from the housing; and

FIG. 14 shows a cross-sectional view of a portion of the dispensing system of FIG. 1 taken along a plane that bisects the housing approximately midway between a front side and a back side of the housing, where the fluid dispenser comprises a non-mixing dispenser.

### DETAILED DESCRIPTION

In fluid material dispensing systems that mix two or more fluid materials, it may be desirable to quickly switch out a fluid dispenser from a pump housing with another fluid dispenser or a plug that closes off the outlets of the pumps. For example, it may be desirable to quick switch between a mixing dispenser that mixes the two or more fluids and a non-mixing dispenser that does not mix the two or more fluids. The non-mixing dispenser may be used to measure an amount of fluid material being dispensed from each pump so that the ratios of the fluid materials can be adjusted to achieve a desired mixture. Therefore, discussed herein are examples of fluid material dispensing systems in which the fluid dispensers can be quickly coupled to, and decoupled from, a housing that supports at least one pump.

In addition, conventional fluid dispensing systems commonly have fluid passages that are difficult to access for cleaning. As a result, conventional fluid dispensing systems must typically be disassembled for cleaning. This can be a cumbersome, time-consuming process. Therefore, discussed herein are examples of fluid material dispensing systems in which the fluid passages can be easily accessed for cleaning without requiring disassembly of the systems.

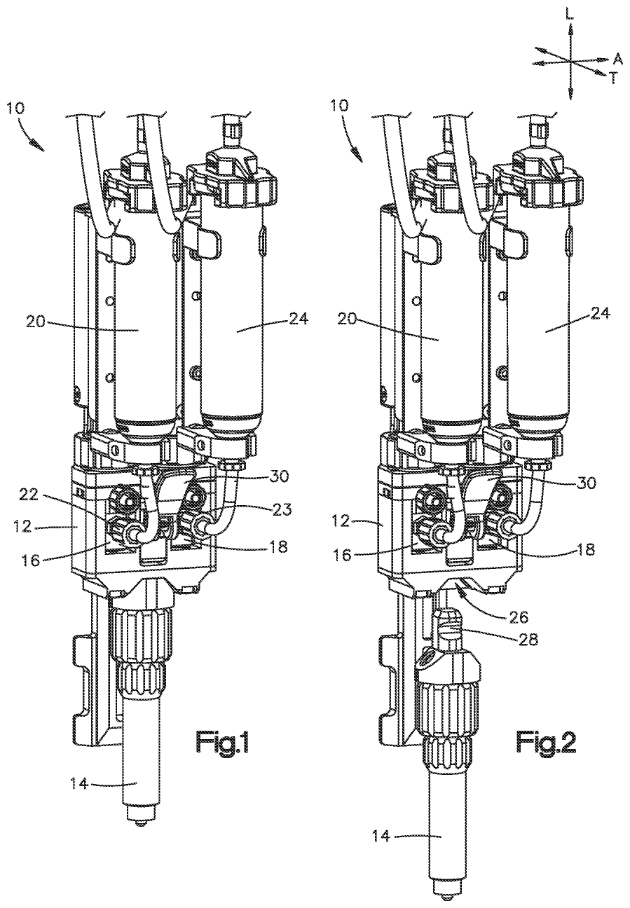

Referring to FIGS. 1 and 2, a fluid material dispensing system 10 is shown according to one example that is configured to dispense at least a first fluid material and a second fluid material. In general, the system 10 comprises a housing 12 and at least one fluid dispenser 14 that are configured to releasably couple to one another. The fluid dispenser 14 can be a mixing dispenser that is configured to mix the first and second fluid materials and dispense a mixture of the first and second fluid materials. Alternatively, the fluid dispenser 14 can be a non-mixing dispenser that is configured to dispense the first and second fluid materials separately, without mixing the first and second fluid materials with one another. The fluid material dispensing system 10 can be configured to quickly switch the fluid dispenser 14 with another fluid dispenser 14 and/or a plug that limits the fluid material from leaking from the housing. For example, the fluid material dispensing system 10 can be configured to switch between a mixing dispenser and a non-mixing dispenser.

The housing 12 defines a receptacle 26, and the fluid dispenser 14 defines a plug 28 that is configured to be received by the receptacle 26. As will be discussed in further detail below, the system 10 includes an engagement feature that is configured to engage a corresponding engagement feature of the fluid dispenser 14 when the fluid dispenser 14 is coupled to the housing 12 so as to releasably secure the fluid dispenser 14 to the housing 12. For example, the system 10 can include a fastener 30 that is configured to move the engagement feature of at least one of the housing 12 and the fluid dispenser 14 between (1) a locked position, wherein the engagement features engage one another with sufficient engagement force so as to prevent the plug 28 of the fluid dispenser 14 from being removed from the receptacle 26 of the housing 12, and (2) an unlocked position, wherein the engagement force is reduced so as to permit the plug 28 of the fluid dispenser 14 to be removed from the receptacle 26 of the housing 12. As such, the fluid dispenser 14 can be quickly coupled to, and decoupled from, the housing 12.

The system 10 comprises a pump system that is supported by the housing 12 and configured to pump the first and second fluid materials to the fluid dispenser 14. For example, the pump system can comprise a first pump 16 configured to pump the first fluid material to the fluid dispenser 14, and a second pump 18 configured to pump the second fluid material to the fluid dispenser 14. The housing 12 is configured to support at least a portion of the pump system, such as at least a portion of each of the first pump 16 and the second pump 18. The system 10 can comprise a first supply 20 that stores the first fluid material and is in fluid communication with an inlet 22 of the first pump 16. The first pump 16 can be configured to pump the first fluid material to the fluid dispenser 14 at a first flow rate. The system 10 can comprise a second supply 24 that stores the second fluid material and is in fluid communication with an inlet 23 of the second pump 18. The second pump 18 can be configured to pump the second fluid material to the fluid dispenser 14 at a second flow rate. The second flow rate can be less than, greater than, or equal to the first flow rate.

The first and second pumps 16 and 18 may each pump consistent and/or constant amounts of material (i.e., the first fluid material and the second fluid material, respectively) from their respective outlets. The amount of materials pumped from the first and second pumps 16 and 18 may be equivalent or different from each other depending on, e.g., the size and/or pump speed of each of the respective first and second pumps 16 and 18. Each pump can be a progressive cavity pump or any other suitable pump that pumps a respective one of the first and second fluid materials at a respective first and second pressure/amount. Accordingly, the respective amounts (e.g., volume) of the first and second fluid materials pumped from the first and second pumps 16 and 18 may be constant. The progressive cavity pumps may produce material feed pressures up to 30 barg (approximately 435.11 psig) at the respective outlets of the first and second pumps 16 and 18 while requiring comparatively low pressures at the feed. This eliminates the need for high pressure pneumatic systems in dispensing applications requiring a high pressure feed. A representative progressive cavity pump in accordance with aspects of the invention is described in U.S. application Ser. No. 15/743,659, published as WO 2017/0023895, the disclosure of which is hereby incorporated by reference herein in its entirety.

Additionally or alternatively, the first pump 16 and the second pumps 18 may be configured to independently pump the respective first and second fluid materials such that a mix ratio between the first material and the second material can be varied. For example, the pump system can include a first motor (not labeled) that can be operatively connected to and can drive the first pump 16. The pump system can include a second motor (not labeled) that can be operatively connected to and can drive the second pump 18. By changing the pump speed(s) of at least one of the first and second motors, the mix ratio may be adjusted. In an alternative example (not shown), dispense system 10 can include an alternate pump system having a single motor. The single motor can drive both the first pump 16 and the second pump 18 such that a mix ratio between the first and second fluid materials is fixed based upon the respective relative sizes of the first and second pumps 16 and 18.

It will be understood that one or more, up to all, of the housing 12, the fluid dispenser 14, the first pump 16, the second pump 18, the first supply 20, the second supply 24, the first motor, and the second motor can be distributed separately. Therefore, dispensing systems of the present disclosure can include the housing 12, and one or more, up to all, of the fluid dispenser 14, the first pump 16, the second pump 18, the first supply 20, the second supply 24, the first motor, and the second motor. Further, in some examples, the system can comprise two or more fluid dispensers 14, including one configured as a mixing dispenser and one configured as a non-mixing dispenser.

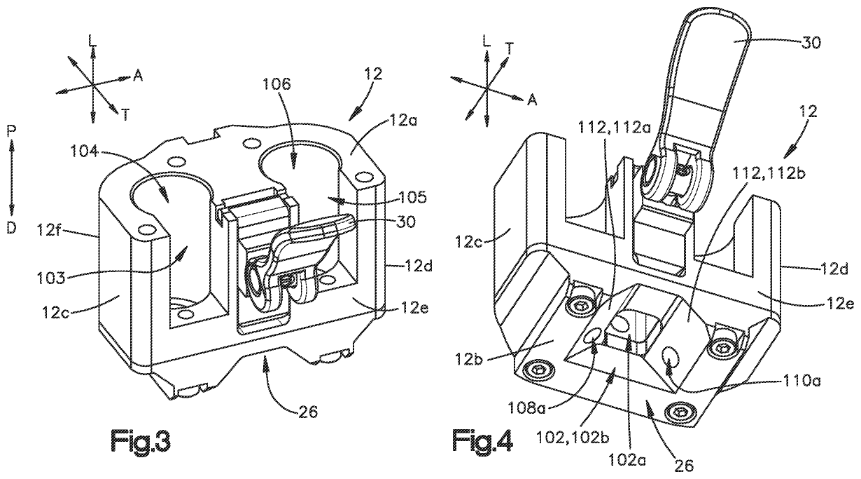

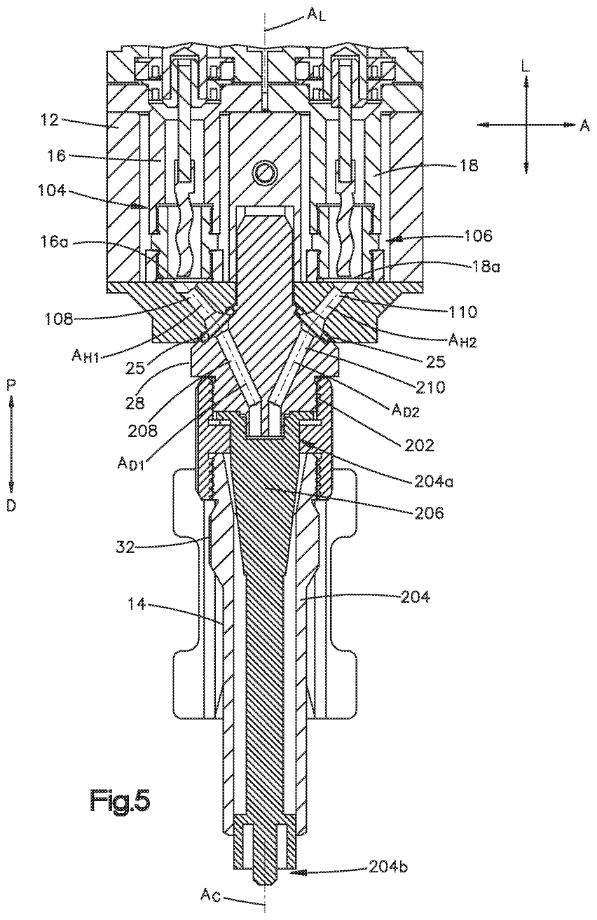

Turning now to FIGS. 3 and 4, the housing 12 can have a proximal end 12a and a distal end 12b that are offset from one another along a longitudinal direction L. A direction that extends from the proximal end 12a to the distal end 12b can be considered a distal direction D, while a direction from the distal end 12b to the proximal end 12a can be considered a proximal direction P, whereas the longitudinal direction L can be bidirectional. The housing 12 can have a first side 12c and a second side 12d that are offset from one another along a lateral direction A. The housing 12 can have a front side 12e and a back side 12f that are offset from one another along a transverse direction T. The receptacle 26 can define at least one hole 102 that extends into the distal end 12b along the longitudinal direction L. The at least one hole 102 can be configured to receive at least one projection 214 of the plug 28 of the fluid dispenser 14. It will be understood that, in alternative examples, the receptacle 26 could define more than one hole 102, and the plug 28 can include more than one projection 214, each configured to be received in a corresponding hole 102 of the receptacle 26.

The housing 12 can define at least one cavity that is configured to receive at least a portion of the pump system therein. For example, the housing 12 can define a first cavity 104 that receives at least a portion of the first pump 16 that includes a pump outlet 16a (labeled in FIG. 5) of the first pump 16 (herein referred to as a first pump outlet), and a second cavity 106 that receives at least a portion of the second pump 18 that includes a second pump outlet 18a (labeled in FIG. 5) of the second pump 18 (herein referred to as a second pump outlet). In alternative examples (not shown), the housing 12 can define a single cavity receives the first and second pumps 16 and 18 therein. Each cavity 104 and 106 can be open at the proximal end 12a of the housing 12 such that the first and second pumps extend therefrom. In alternative examples (not shown), each cavity 104 and 106 can be closed at the proximal end 12a, and the first and second pumps 16 and 18 can be enclosed within each cavity 104 and 106 by the proximal end 12a. The first and second cavities 104 and 106 can be spaced from one another, such as along the lateral direction A. The at least one hole 102 of the receptacle 26 can extend into the housing 12 between the first and second cavities 104 and 106, and thus, between the first and second pumps 16 and 18.

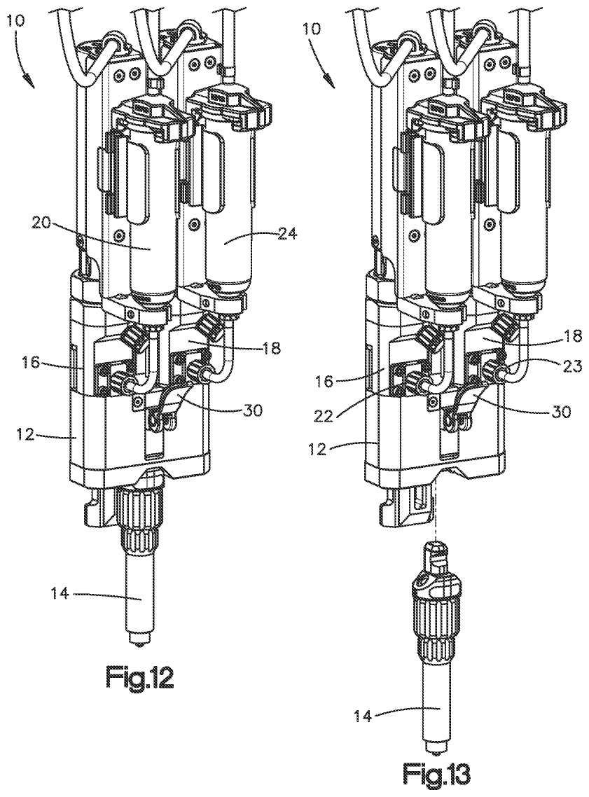

The housing 12 can define at least one hole that extends into a side of the housing 12 to at least one of the cavities 104 and 106. Each hole can be configured to receive an inlet of the pump assembly. For example, the housing 12 can define a first hole 103 that extends into a side 12e to the first cavity 104 and a second hole 105 that extends into a side 12e to the second cavity 106. As shown in FIGS. 1 and 2, the first hole 103 can be configured to receive the first inlet 22 of the first pump 16 therethrough from the first supply 20, and the second hole 105 can be configured to receive a second inlet 23 of the second pump 18 therethrough from the second supply 24. It will be understood that, in alternative embodiments as shown in FIGS. 12 and 13, the housing 12 can be devoid of the first and second holes 103 and 105, and the inlets 22 and 23 can extend to the first and second pumps 16 and 18, respectively, at a location outside of the first housing 12.

Referring to FIGS. 4 and 5, the housing 12 defines at least one passage that extends from the at least one hole to the at least one cavity. For example, the housing 12 can define a first passage 108 that extends from the at least one hole 102 to the first cavity 104. The first passage 108 can extend to the first pump outlet 16a of the first pump 16 when the first pump 16 is supported by the housing 12. The first passage 108 is configured to communicate the first fluid material from the first pump outlet 16a to the fluid dispenser 14 when the fluid dispenser 14 is coupled to the housing 12. The first passage 108 can be straight as shown or can be curved or bent. The housing 12 defines a second passage 110 that extends from the at least one hole 102 to the second cavity 106. For example, the second passage 110 can extend to the second pump outlet 18a of the second pump 18 when the second pump 18 is supported by the housing 12. The second passage 110 is configured to communicate the second fluid material from the second pump outlet 18a to the fluid dispenser 14 when the fluid dispenser 14 is coupled to the housing 12. The second passage 110 can be straight as shown or can be curved or bent.

At least a portion of the first passage 108 can extend along a first oblique axis A_{H1} that is oblique relative to the longitudinal direction L. The first oblique axis A_{H1} can be angled away from the pump system as the first oblique axis A_{H1} extends towards the at least one hole 102. Stated differently, the first oblique axis A_{H1} can be angled towards the pump system as the first oblique axis A_{H1} extends away from the at least one hole 102. In one example, the portion of the first passage 108 that extends along the first oblique axis A_{H1} can extend from the at least one hole 102 towards the first pump outlet 16a. In another example, an entirety of the first passage 108 can extend from the at least one hole 102 to the first pump outlet 16a along the first oblique axis A_{H1}. The first oblique axis A_{H1} does not intersect the housing 12 as the first oblique axis A_{H1} extends away from the first passage 108 through the at least one hole 102. Thus, the first passage 108 is configured to be accessed along a first path that extends through the at least one hole 102 to the first passage 108 along the first oblique axis A_{H1}, where the housing 12 does not interference or intersect the first path. Providing such a path can make it easier to clean the first passage 108 when the fluid dispenser 14 is removed.

Similarly, at least a portion of the second passage 110 can extend along a second oblique axis A_{H2} that is oblique relative to the longitudinal direction L. The second oblique axis A_{H2} can be angled away from the pump system as the second oblique axis A_{H2} extends towards the at least one hole 102. Stated differently, the second oblique axis A_{H2} can be angled towards the pump system as the second oblique axis A_{H2} extends away from the at least one hole 102. As shown, the first and second passages 108 and 110 can be disposed on opposing sides of the at least one hole 102 and can diverge away from one another as they extend along the distal direction. In one example, the portion of the second passage 110 that extends along the second oblique axis A_{H2} can extend from the at least one hole 102 towards the second pump outlet 18a. In another example, an entirety of the second passage 110 can extend from the at least one hole 102 to the second pump outlet 18a along the second oblique axis A_{H2}. The second oblique axis A_{H2} does not intersect the housing 12 as the second oblique axis A_{H2} extends away from the second passage 110 through the at least one hole 102. Thus, the second passage 110 is configured to be accessed along a second path that extends through the at least one hole 102 to the second passage 110 along the second oblique axis A_{H2}, where the housing 12 does not interference or intersect the second path. Providing such a path can make it easier to clean the second passage 110 when the fluid dispenser 14 is removed.

The housing 12 comprises at least one inner surface 112 that at least partially defines the at least one hole 102. The at least one inner surface 112 can define a first opening 108a to the first passage 108a and a second opening 110a to the second passage 110. The at least one inner surface 112 can be straight or curved or bent. At least a portion of the at least one inner surface 112 can extend along a direction that is oblique relative to the longitudinal direction L. For example, the at least one inner surface 112 can include a first surface portion 112a that can be angled away from the pump system as the first surface portion 112a extends away from the at least one hole 102. Stated differently, the first surface portion 112a can be angled towards the pump system as the first surface portion 112a extends towards the at least one hole 102. The first surface portion 112a can define the opening 108a to the first passage 108a. The at least one inner surface 112 can include a second surface portion 112b that can be angled away from the pump system as the second surface portion 112b extends away from the at least one hole 102. Stated differently, the second surface portion 112b can be angled towards the pump system as the second surface portion 112b extends towards the at least one hole 102. As shown, the first and second portions 112a and 112b can be disposed on opposing sides of the at least one hole 102 and can diverge away from one another as they extend in the distal direction. The first and second portions 112a and 112b can be configured to mate with corresponding first and second portions 212a and 212b of at least one outer surface 212 of the fluid dispenser 14.

The at least one hole 102 has a proximal portion 102a and a distal portion 102b. The distal portion 102b can be disposed closer to distal end 12b of the housing 12 and the proximal portion 102a can be disposed closer to the proximal end 102a of the housing 12. The distal portion 102b can be open at the distal end 12b so as to receive the plug 28. The distal portion 102b can have a cross-sectional dimension along a perpendicular direction that is perpendicular to the longitudinal direction L that is greater than a cross-sectional dimension of the proximal portion 102a along the perpendicular direction. The perpendicular direction can be the lateral direction A. The proximal portion 102a can be configured to receive the projection 214 of the plug 28. The opening 102 can have a keyed shape that is configured to conform to a keyed shape of the plug 28 such that, when the plug 28 is received in the opening 102, the keyed shapes prevent the plug 28 from rotating in the opening 102 relative to the housing 12 about a longitudinal axis A_{L} that extends along the longitudinal direction L. The keyed shapes of each of the opening 102 and the plug 28 can be non-circular shapes. The keyed shapes can be configured such that the plug 28 can be received in the opening 102 in one rotational orientation about the longitudinal axis A_{L}. In other embodiments, the keyed shapes can be configured such that the plug 28 can be received in the opening 102 in more than one rotational orientation about the longitudinal axis A_{L}.

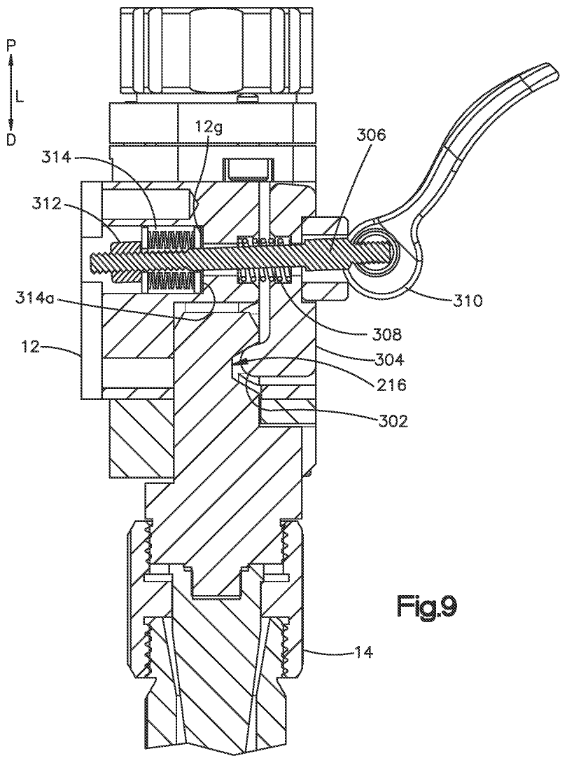

Turning now to FIGS. 5 to 8, an example of the fluid dispenser 14 is shown in which the fluid dispenser 14 comprises the plug 28 and a mixer 32. The mixer 32 is configured to mix the first and second fluid materials to form a mixture of the first and second fluid materials. The plug 28 and mixer 32 can be separate parts that are configured to be removably coupled to one another as shown. In one example, plug 28 can have threading that is configured to mate with corresponding threading 202 of the mixer 32 so as to couple the plug 28 and mixer 32 to one another. It will be understood that the plug 28 and mixer 32 can be coupled together using any other suitable fastener. In other examples, the plug 28 and mixer 32 can be fixedly attached to one another.

The mixer 32 can be configured as a static mixer, meaning that the mixer 32 can mix the first and second fluid materials without causing any internal components to move to mix the materials. It will be understood that, in alternative examples, the mixer 32 can be an active mixer that comprises moving components that mix the first and second fluid materials. The mixer 32 can have a body 204 that has a first end 204a and a second end 204b that are offset from one another. In one example, the body 204 can have a tubular shape that extends along a central axis A_{C}. The central axis A_{C} can be aligned with or offset from the longitudinal axis A_{L} and can extend along the longitudinal direction. It will be understood that the body 204 can have any other suitable shape. A direction that extends from the first end 204a to the second end 204b can be considered a distal direction D, while a direction from the second end 204b to the proximal end 204a can be considered a proximal direction P, whereas the longitudinal direction L can be bidirectional. The first end 204a can be configured to couple to the plug 28. The second end 204b can define a nozzle that is configured to dispense the mixture. The tubular body 204 defines at least one mixing chamber 206 therein that extends between the first end 204a to the second end 204b. The at least one mixing chamber 206 is configured to receive the first and second fluid materials and mix the first and second fluid materials to form the mixture that is dispensed from the nozzle.

The fluid dispenser 14 defines at least one passage that extends into at least one outer surface 212 of the fluid dispenser 14 to the at least one mixing chamber 206. For example, the fluid dispenser 14 can define a first passage 208 that extends into the at least one outer surface 212 to the at least one mixing chamber 206. The first passage 208 is configured to be in fluid communication with the first passage 108 of the housing 12 when the fluid dispenser 14 is coupled to the housing 12. For example, the first passage 208 is configured to receive the first fluid material from the first passage 108 of the housing 12 and direct the first fluid material to the at least one mixing chamber 206. The first passage 208 can be straight as shown or can be curved or bent. The fluid dispenser 14 can define a second passage 210 that extends into the at least one outer surface 212 to the at least one mixing chamber 206. The second passage 210 is configured to be in fluid communication with the second passage 110 of the housing 12 when the fluid dispenser 14 is coupled to the housing 12. For example, the second passage 210 is configured to receive the second fluid material from the second passage 110 of the housing 12 and direct the second fluid material to the at least one mixing chamber 206. The second passage 210 can be straight as shown or can be curved or bent.

At least a portion of the first passage 208 can extend along a first oblique axis A_{D1} that is oblique relative to the longitudinal direction L. The oblique axis A_{D1} can be angled away from the central axis A_{C} as the oblique axis A_{D1} extends towards the second end 204b. Stated differently, the first oblique axis A_{D1} can be angled towards the central axis A_{C} as the first oblique axis A_{D1} extends towards the second end 204b. In one example, the portion of the first passage 208 that extends along the first oblique axis A_{D1} can extend from the at least one outer surface 212 towards the at least one mixing chamber 206. In another example, an entirety of the first passage 208 can extend from the at least one outer surface 212 to the at least one mixing chamber 206.

Similarly, at least a portion of the second passage 210 can extend along a second oblique axis A_{D2} that is oblique relative to the longitudinal direction L. The oblique axis A_{D2} can be angled away from the central axis A_{C} as the oblique axis A_{D2} extends towards the second end 204b. Stated differently, the second oblique axis A_{D2} can be angled towards the central axis A_{C} as the second oblique axis A_{D2} extends towards the second end 204b. In one example, the portion of the second passage 210 that extends along the second oblique axis A_{D2} can extend from the at least one outer surface 212 towards the at least one mixing chamber 206. In another example, an entirety of the second passage 210 can extend from the at least one outer surface 212 to the at least one mixing chamber 206. As shown, the first and second passages 208 and 210 can be disposed on opposing sides of the central axis A_{C} and can converge towards one another as they extend towards the second end 204b.

The at least one outer surface 212 can define a first opening 208a to the first passage 208a and a second opening 210a to the second passage 210. The at least one outer surface 212 can be straight or curved or bent. At least a portion of the at least one outer surface 212 can extend along a direction that is oblique relative to the longitudinal direction L. For example, the at least one outer surface 212 can include a first surface portion 212a that can be angled away from the central axis A_{C} as the first surface portion 212a extends towards the second end 204b. Stated differently, the first surface portion 212a can be angled towards the central axis A_{C} as the first surface portion 212a extends away from the second end 204b. The first surface portion 212a can define the first opening 208a to the first passage 208. The at least one outer surface 212 can include a second surface portion 212b that can be angled away from the central axis A_{C} as the second surface portion 212b extends towards the second end 204b. Stated differently, the second surface portion 212b can be angled towards the central axis A_{C} as the second surface portion 212b extends away from the second end 204b. The second surface portion 212b can define the second opening 208b to the second passage 210. As shown, the first and second portions 212a and 212b can be disposed on opposing sides of the central axis A_{C} and can diverge away from one another as they extend towards the second end 204b.

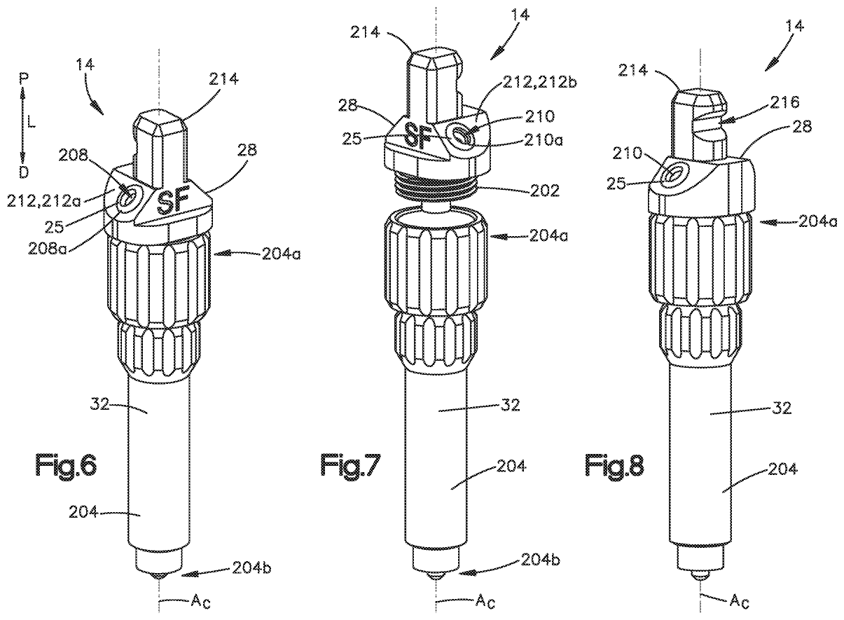

The first and second portions 212a and 212b can be configured to face and/or mate with corresponding first and second portions 112a and 112b of the at least one inner surface 112 of the housing 12. An interface between the first surface portion 112a of the housing and the first surface portion 212a of the fluid dispenser 14 can include a seal, such as an O-ring 25 (shown in FIGS. 5 and 6), around the first passages 108 and 208 so as to prevent leakage of the fluid. Similarly, an interface between the second surface portion 112b of the housing and the second surface portion 212b of the fluid dispenser 14 can include a seal, such as an O-ring 25 (shown in FIGS. 5 and 7), around the second passages 110 and 210 so as to prevent leakage of the fluid.

The plug 28 can comprise a projection 214 that extends from the at least one outer surface 212 away from the second end 204b. The projection 214 can be configured to be received in the proximal portion 102a of the hole 102 of the housing 12. The projection 214 can have a cross-sectional dimension in a perpendicular direction that is perpendicular to the central axis A_{C}, the cross-sectional dimension being less than a cross-sectional dimension of the at least one outer surface 212 in the perpendicular direction. In one example, the projection 214 can include an engagement feature 216 that is configured to engage a corresponding engagement feature 302 of the housing 12 so as to releasably secure the fluid dispenser 14 to the housing 12. The engagement features 302 and 216 can be configured to engage one another within the housing 12. In one example, the engagement feature 216 of the fluid dispenser 14 can define a recess and the engagement feature 302 of the fastener 30 can define a protrusion that is configured to be received by the recess. The recess can extend into the projection 214 towards the central axis A_{C}, such as into the projection 214 along the perpendicular direction. In another example, the engagement feature 216 of the fluid dispenser 14 can define the protrusion and the engagement feature 302 of the fastener 30 can define the recess.

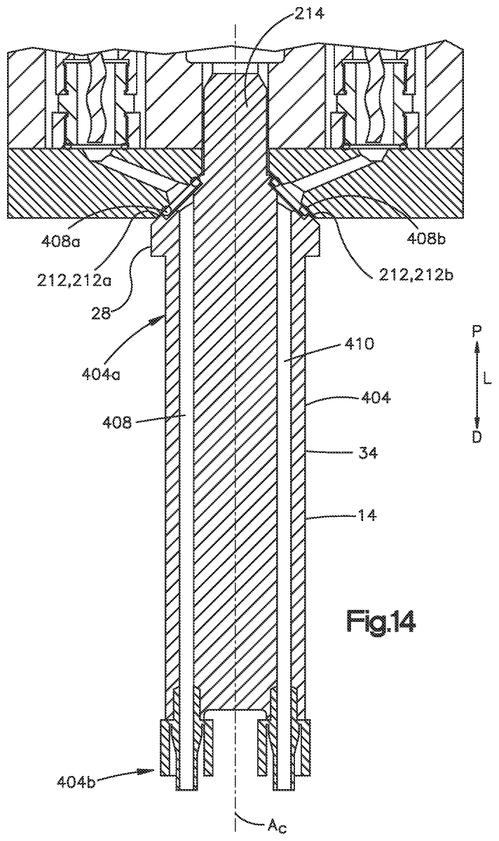

Turning briefly to FIG. 14, another example of a fluid dispenser 14 is shown. The fluid dispenser 14 of FIG. 14 is a non-mixing dispenser that is configured to dispense the first and second fluid materials separately, without mixing the first and second fluid materials with one another. The fluid dispenser 14 has a plug 28 and a dispenser 34 that can be removable or fixedly attached to one another in a manner similar to that described above in relation to the plug 28 and mixer 32. The plug 28 can have at least one outer surface 212 and at least one projection 214 that are configured in a manner to that described above in relation to FIGS. 5 to 8.

The dispenser 34 can have a body 404 that has a first end 404a and a second end 404b that are offset from one another. The body 404 can have a tubular shape that extends along a central axis A_{C} or any other suitable shape. In another example, the body 404 can define a pair of tubes that extend along respective central axes. The central axis A_{C} can be aligned with or offset from the longitudinal axis A_{L}. It will be understood that the body 404 can have any other suitable shape. The first end 404a can be configured to couple to the plug 28. The second end 404b can define at least one nozzle, such as first and second nozzles, that are configured to dispense the first and second fluid materials, respectively.

The body 404 defines at least one passage that extends from the at least one outer surface 212 of the fluid dispenser 14 to the second end 404b. For example, the body 404 can define a first passage 408 that extends into the at least one outer surface 212 to the second end 404b. The first passage 408 is configured to be in fluid communication with the first passage 108 of the housing 12 when the fluid dispenser 14 is coupled to the housing 12. For example, the first passage 408 is configured to receive the first fluid material from the first passage 108 of the housing 12 and direct the first fluid material to the first nozzle at the second end 404b. The first passage 408 can be straight as shown or can be curved or bent. The body 404 can define a second passage 410 that extends from the at least one outer surface 212 to the second end 404b. The second passage 410 is configured to be in fluid communication with the second passage 110 of the housing 12 when the fluid dispenser 14 is coupled to the housing 12. For example, the second passage 410 is configured to receive the second fluid material from the second passage 110 of the housing 12 and direct the second fluid material to the second nozzle at the second end 404b. The second passage 410 can be straight as shown or can be curved or bent. The first and second passages 408 and 410 can be spaced from one another on opposed sides of the central axis A_{C}.

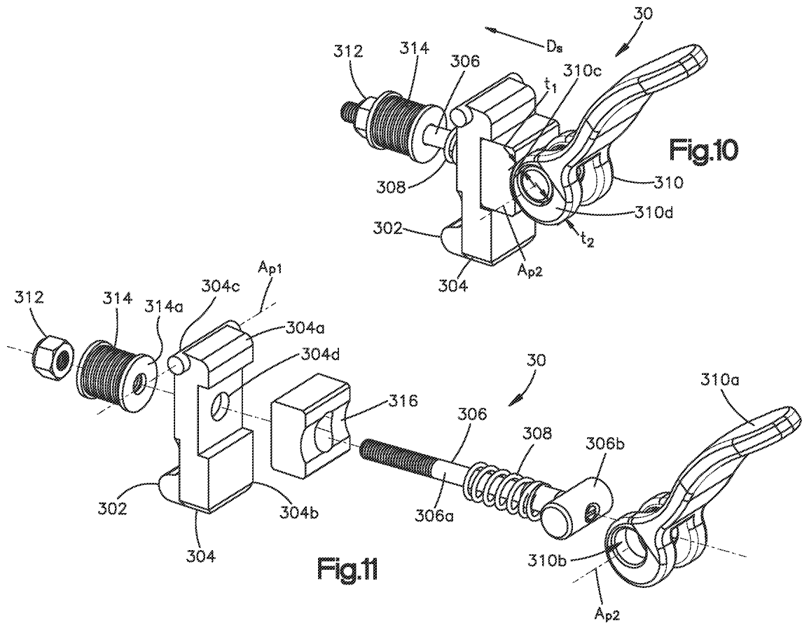

Referring now to FIGS. 9 to 11, one example of a fastener 30 is shown. The fastener 30 comprises an engagement feature 302 that is configured to engage the engagement feature 216 of the fluid dispenser 14. The fastener 30 can be configured to move the engagement feature 302 between (1) a locked position, wherein the engagement features 302 and 216 engage one another with sufficient engagement force so as to prevent the plug 28 of the fluid dispenser 14 from being removed from the receptacle 26 of the housing 12, and (2) an unlocked position, wherein the engagement force is reduced so as to permit the plug 28 of the fluid dispenser 14 to be removed from the receptacle 26 of the housing 12. For example, the fastener 30 can include an actuator that is configured to move the engagement feature 302 between the locked and unlocked configuration. The actuator can comprise a screw 306, a resilient member 308, a cam member 310, a threaded nut 312, and a resilient member 314.

The fastener 30 comprises a movable fastener body 304 that defines the engagement feature 302. The movable fastener body 304 can have a first end 304a and a second end 304b that are offset from one another. The first end 304a can define a pivot axis A_{P1}. The second end 304b can define the engagement feature 302. For example, the engagement feature 302 can be a protrusion that extends inwardly towards the housing 12 when the fastener 30 is coupled to the housing 12. In other examples, the engagement feature 302 can define a recess that extends into the movable fastener body 304 outwardly from the housing 12. The movable fastener body 304 can define a hole 304d therethrough that receives the screw 306 of the actuator therethrough. The hole 304d can extend through the moveable fastener body 304 along an inward direction towards the housing 12.

The actuator is configured such that actuation of the actuator in a first direction causes at least a portion of the fastener body 304, such as a portion including the engagement feature 302, to move towards the engagement feature 216 of the fluid dispenser 14, and actuation of the actuator in a second direction causes at least a portion of the fastener body 304, such as a portion including the engagement feature 302, to move away from the engagement feature 216 of the fluid dispenser 14. For example, the fastener body 304 can be configured to pivot about the pivot axis A_{P1} relative to the housing 12. The pivot axis A_{P1} can extend in a perpendicular direction that is substantially perpendicular to the longitudinal axis A_{L}. The pivot axis A_{P1} can be defined by a pivot pin 304c that is configured to engage the housing 12. The actuator can be configured to cause the movable fastener body 304 to pivot about the pivot axis A_{P1}. In other embodiments, the actuator can be configured to cause an entirety of the movable fastener body 304 to translate inwardly towards the housing 12 and outwardly away from the housing 12.

The actuator can include an engagement surface 314a that is configured to engage an inner surface 12g of the housing 12 so as to trap at least a portion of the housing 12 and the movable fastener body 304 between the engagement surface 314a and the cam member 310. The engagement surface 314a can be a surface of the resilient member 314. The resilient member 314 can comprise, for example, a spring or resilient material, that is configured to apply a biasing force that biases the engagement feature 302 towards the engagement feature 216. For example, the resilient member 314 can bias the nut 312 in a select direction D_{S} that extends from a head 306b of the fastener 306 towards a shaft 306a of the fastener 306. The nut 312 can bias the fastener 306 in the select direction D_{S}, which in turn can bias the engagement feature 302 of the fastener body 304 in the select direction D_{S} towards the engagement feature 216. The resilient member 314 can control an amount of biasing force that is applied by the engagement feature 302 to the engagement feature 216. Thus, a resilient member 314 with a greater spring force will cause the engagement feature 302 to apply a greater biasing force to the engagement feature 216 than a resilient member 314 with a smaller spring force.

The resilient member 308 can be disposed about a shaft 306a of the screw 306 between the engagement surface 314a and the cam member 310 so as to apply an outward biasing force to the cam member 310. The resilient member 308 can be, for example, a spring or resilient material, that is configured to bias the fastener body 304 towards the cam member 310 so as to maintain the cam member 310 in the unlocked position when the cam member 310 is in the unlocked position and in the locked position when the cam member 310 is in the locked position.

The cam member 310 can have a curved outer shape that can be partially or entirely circular. The cam member 310 can define a handle 310a that can be grasped by a user to rotate the cam member 310a. The cam member 310 can define a hole 310b at least partially therethrough that is configured to receive a head 306b of the screw 306 such that the cam member 310 pivots about a pivot axis A_{P2} defined by the head 306b. The hole 310b, and thus the pivot axis A_{P2}, can be offset from a central axis of the cam member 310. As a result, a first portion 310c of the cam member 310 defines a first thickness t₁ that extends in a first radial direction from the pivot axis A_{P2}, and a second portion 310d of the cam member 310 defines a second thickness t₂ that extends in a second radial direction from the pivot axis A_{P2}, the second thickness t₂ being greater than the first thickness t₁. In alternative examples, the cam member 310 can have an outer shape that is partially or entirely oblong, and the central axis of the hole 310a can be more centrally located. The cam member 310 can be rotated relative to the housing 12 between (1) the unlocked configuration, wherein the first portion 310c engages an abutment surface 316 of the fastener 30 so as to permit the engagement feature 302 of the fastener 30 to move away from the engagement feature 216 of the fluid dispenser 14, and (2) the locked configuration, wherein the second portion 310d engages the abutment surface 316 of the fastener 30 so as to cause the engagement feature 302 of the fastener 30 to move towards the engagement feature 216 of the fluid dispenser 14.

It will be understood that the fastener 30 can be configured in any other suitable matter to move the engagement feature 302 of the fastener 30 into engagement with the engagement feature 216 of the fluid dispenser 14. For example, instead of a cam member 310, the screw 306 could include a head that is configured to be engaged by a driving instrument such as screw driver or wrench. In such example, rotation of the screw in a first direction could cause the engagement feature 302 to move towards the engagement feature 216, and rotation of the screw in a second direction, opposite the first direction, could enable the engagement feature 302 to move away from the engagement feature 216. In another embodiment, the fastener 30 could be a ball detent having an engagement feature that is a retractable ball that engages a recess of the fluid dispenser 14.

To assemble the fluid material dispensing system, the plug 28 of the fluid dispenser 14 is aligned with the receptacle 26 of the housing 12. The plug 28 is then inserted in the receptacle 26 such that the first and second fluid passages 208 and 210 of the fluid dispenser 14 are in fluid communication with the first and second fluid passages 108 and 110 of the housing, respectively, and such that 1) the first fluid passages 108 and 208 of the fluid dispenser 14 and the housing 12 are in fluid communication with one another and configured to direct a first fluid material from the first pump 16 to at least one nozzle of the fluid dispenser 14, and 2) the second fluid passages 110 and 210 of the fluid dispenser 14 and the housing are in fluid communication with one another and configured to direct a second fluid material from the second pump 18 to the at least one nozzle. The fastener 30 is then actuated so as to move the engagement feature of at least one of the fluid dispenser 14 and the housing 12 into engagement with an engagement feature of the other of the at least one of the fluid dispenser 14 and the housing 12 so as to releasably secure the fluid dispenser 14 to the housing 12. The inserting step can comprise mating the first inner surface portion 112a of the housing 12 with a first surface portion 212a of the fluid dispenser 14, and mating a second inner surface portion 112b of the housing 12 with a second surface portion 212b of the fluid dispenser 14, wherein the first and second inner surfaces 112a and 112b of the housing 12 diverge away from one another along a distal direction and the first and second inner surface portions 212a and 212b of the fluid dispenser 14 converge towards one another along the distal direction. The inserting step can comprise inserting the plug 28 into a hole 102 defined by the receptacle 26 that extends into the housing 12, and the actuating step can comprise causing the engagement feature 302 of the fastener to move within the hole 102 so as to engage the engagement feature 216 of the plug 28 within the hole 102.

Various aspects of the present disclosure can be understood in view of the following examples:

Example 1. A fluid material dispensing system, comprising:

a housing configured to support at least a portion of each of a first pump and a second pump, the housing defining:

a receptacle that defines at least one hole that extends into the housing that is configured to receive a projection of a plug of a fluid dispenser;

a first passage that extends from the at least one hole to a first pump outlet of the first pump when the first pump is supported by the housing, such that the first passage is configured to communicate a first fluid material from the first pump outlet to the fluid dispenser when the fluid dispenser is coupled to the housing; and

a second passage that extends from the at least one hole to a second pump outlet of the second pump when the second pump is supported by the housing, such that the second passage is configured to communicate a second fluid material from the second pump outlet to the fluid dispenser when the fluid dispenser is coupled to the housing; and

an engagement feature configured to engage a corresponding engagement feature of the plug of the fluid dispenser when the plug is received in the receptacle so as to releasably secure the fluid dispenser to the housing.

Example 2. The fluid material dispensing system of Example 1, wherein the at least one hole extends into the housing along a longitudinal axis, at least a portion of the first passage extends along a first oblique axis that is oblique relative to the longitudinal axis, and at least a portion of the second passage extends along a second oblique axis that is oblique relative to the longitudinal axis.

Example 3. The fluid material dispensing system of Example 2, wherein the first and second oblique axes are each angled towards the longitudinal axis as the first and second oblique axes extend towards the at least one hole.

Example 4. The fluid material dispensing system of any of Examples 2 and 3, wherein the portion of the first passage extends from the at least one hole towards the first pump outlet along the first oblique axis, and the portion of the second passage extends from the at least one hole towards the second pump outlet along the second oblique axis.

Example 5. The fluid material dispensing system of any of Examples 2 to 4, wherein an entirety of the first passage extends from the at least one hole to the first pump outlet along the first oblique axis, and an entirety of the second passage extends from the at least one hole to the second pump outlet along the second oblique axis.

Example 6. The fluid material dispensing system of any of Examples 2 to 5, wherein the first oblique axis does not intersect the housing as the first oblique axis extends away from the first passage through the at least one hole, and the second oblique axis does not intersect the housing as the second oblique axis extends away from the second passage through the at least one hole.

Example 7. The fluid material dispensing system of any of Examples 2 to 6, wherein the first passage is configured to be accessed along a first path that extends through the at least one hole to the first passage along the first oblique axis, the second passage is configured to be accessed along a second path that extends through the at least one hole to the second passage along the second oblique axis, and the housing does not interfere with either of the first path and the second path.

Example 8. The fluid material dispensing system of any of Examples 1 to 7, wherein the housing comprises at least one inner surface that at least partially defines the at least one hole, the at least one inner surface defining a first opening to the first passage and a second opening to the second passage, the at least one inner surface extending along a direction that is oblique relative to the longitudinal direction.

Example 9. The fluid material dispensing system of Example 8, wherein the at least one inner surface comprises a first inner surface portion that defines the first opening and a second inner surface portion that defines the second opening, wherein the first and second inner surface portions diverge from one another as they extend away from the first and second pumps.

Example 10. The fluid material dispensing system of any of Examples 1 to 9, wherein the at least one hole has a proximal portion configured to receive a projection of the fluid dispenser, and a distal portion, the distal portion having a cross-sectional dimension along a perpendicular direction that is perpendicular to the longitudinal axis, the cross-sectional dimension being greater than a cross-sectional dimension of the proximal portion along the perpendicular direction.

Example 11. The fluid material dispensing system of any of Examples 1 to 10, wherein the engagement feature is a recess and the corresponding engagement feature is a protrusion.

Example 12. A fluid dispenser for a material dispensing system, the fluid dispenser comprising:

a dispensing body having a first end and a second end that are offset from one another, the second end comprising at least one nozzle configured to dispense first and second fluid materials;
a plug attached to the first end of the dispensing body and configured to be received in a receptacle of a housing that supports first and second pumps of the fluid material dispensing system, the plug comprising:

at least one outer surface that defines first and second openings; and

at least one projection that extends from the at least one outer surface, the projection configured to be received in a hole of the receptacle and defining an engagement feature that is configured to engage a corresponding engagement feature of the housing,

wherein the fluid dispenser defines 1) a first fluid passage that extends from the first opening towards the at least one nozzle, the first fluid passage being configured to direct a first fluid material from the first pump towards the at least one nozzle, and 2) a second fluid passage that extends from the second opening towards the at least one nozzle, the second fluid passage being configured to direct a second fluid material from the second pump towards the at least one nozzle.

Example 13. The fluid dispenser of Example 12, wherein the dispensing body defines a mixer that comprises a mixing chamber configured to mix the first and second fluid materials into a mixture, the first and second fluid passages extend from the first and second openings, respectively, to the mixing chamber, and the mixing chamber is configured to direct the mixture to the nozzle.

Example 14. The fluid dispenser of Example 12, wherein the dispensing body defines a non-mixing dispenser, the first passage extends from the first opening towards a first nozzle of the least one nozzle such that the first passage is configured to direct a first fluid material to the first nozzle, and the second passage extends from the second opening towards a second nozzle of the at least one nozzle such that the second passage is configured to direct a second fluid material to the second nozzle.

Example 15. The fluid dispenser of any of Examples 12 to 14, wherein at least a portion of the first passage extends along a first oblique axis that is oblique relative to a central axis of the fluid dispenser, and at least a portion of the second passage extends along a second oblique axis that is oblique relative to the central axis.

Example 16. The fluid dispenser of Example 15, wherein the first and second oblique axes are angled away from the central axis as the first and second oblique axes extend toward the second end.

Example 17. The fluid dispenser of any of Examples 15 and 16, wherein the portion of the first passage that extends along the first oblique axis extends from the at least one outer surface, and the portion of the second passage that extends along the second oblique axis extends from the at least one outer surface.

Example 18. The fluid dispenser of any of Examples 15 to 17, wherein the first and second passages converge towards one another as they extend towards the second end.

Example 19. The fluid dispenser of any of Examples 12 to 18, wherein the at least one outer surface includes first and second surface portions that are angled away from a central axis of the fluid dispenser as the first and second surface portions extend toward the second end, the first and second surface portions defining the first and second openings, respectively.

Example 20. The fluid dispenser of Example 19, wherein the first and second surface portions diverge away from one another as they extend towards the second end.

Example 21. A method of assembling a fluid material dispensing system, the method comprising:

aligning a plug of a fluid dispenser with a receptacle of a housing, the housing configured to support first and second pumps of the fluid material dispensing system,
inserting the plug in the receptacle such that first and second fluid passages of the fluid dispenser are in fluid communication with first and second fluid passages of the housing, respectively, and such that 1) the first fluid passages of the fluid dispenser and the housing are in fluid communication with one another and configured to direct a first fluid material from the first pump to at least one nozzle of the fluid dispenser, and 2) the second fluid passages of the fluid dispenser and the housing are in fluid communication with one another and configured to direct a second fluid material from the second pump to the at least one nozzle; and
actuating a fastener so as to move an engagement feature of at least one of the fluid dispenser and the housing into engagement with an engagement feature of the other of the at least one of the fluid dispenser and the housing so as to releasably secure the fluid dispenser to the housing.

Example 22. The method of Example 21, wherein the inserting step comprises mating a first inner surface portion of the housing with a first outer surface portion of the fluid dispenser, and mating a second inner surface portion of the housing with a second outer surface portion of the fluid dispenser, wherein the first and second inner surfaces of the housing diverge away from one another along a distal direction and the first and second inner surfaces of the fluid dispenser converge towards one another along the distal direction.

Example 23. The method of any of Examples 21 and 22, wherein the inserting step comprises inserting the plug into a hole defined by the receptacle that extends into the housing, and the actuating step comprises causing the engagement feature of the fastener to move within the hole so as to engage the engagement feature of the plug within the hole.

Example 24: The fluid material dispensing system of any of Examples 1-11 comprising the fluid dispenser of any of Examples 12-20.

It should be noted that the illustrations and descriptions of the examples shown in the figures are for exemplary purposes only, and should not be construed limiting the disclosure. One skilled in the art will appreciate that the present disclosure contemplates various examples. Additionally, it should be understood that the concepts described above with the above-described examples may be employed alone or in combination with any of the other examples described above. It should further be appreciated that the various alternative examples described above with respect to one illustrated example can apply to all examples as described herein, unless otherwise indicated.

Unless explicitly stated otherwise, each numerical value and range should be interpreted as being approximate as if the word “about,” “approximately,” or “substantially” preceded the value or range. The terms “about,” “approximately,” and “substantially” can be understood as describing a range that is within 15 percent of a specified value unless otherwise stated.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more examples or that one or more examples necessarily include these features, elements and/or steps. The terms “comprising,” “including,” “having,” and the like are synonymous and are used inclusively, in an open-ended fashion, and do not exclude additional elements, features, acts, operations, and so forth.

While certain examples have been described, these examples have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

It will be understood that reference herein to “a” or “one” to describe a feature such as a component or step does not foreclose additional features or multiples of the feature. For instance, reference to a device having or defining “one” of a feature does not preclude the device from having or defining more than one of the feature, as long as the device has or defines at least one of the feature. Similarly, reference herein to “one of” a plurality of features does not foreclose the invention from including two or more, up to all, of the features. For instance, reference to a device having or defining “one of a X and Y” does not foreclose the device from having both the X and Y.

1. A fluid material dispensing system, comprising:
a housing configured to support at least a portion of each of a first pump and a second pump, the housing defining:
a receptacle that defines at least one hole that extends into the housing that is configured to receive a projection of a plug of a fluid dispenser;
a first passage that extends from the at least one hole to a first pump outlet of the first pump when the first pump is supported by the housing, such that the first passage is configured to communicate a first fluid material from the first pump outlet to the fluid dispenser when the fluid dispenser is coupled to the housing; and
a second passage that extends from the at least one hole to a second pump outlet of the second pump when the second pump is supported by the housing, such that the second passage is configured to communicate a second fluid material from the second pump outlet to the fluid dispenser when the fluid dispenser is coupled to the housing; and
an engagement feature configured to engage a corresponding engagement feature of the plug of the fluid dispenser when the plug is received in the receptacle so as to releasably secure the fluid dispenser to the housing.

2. The fluid material dispensing system of claim 1, wherein the at least one hole extends into the housing along a longitudinal axis, at least a portion of the first passage extends along a first oblique axis that is oblique relative to the longitudinal axis, and at least a portion of the second passage extends along a second oblique axis that is oblique relative to the longitudinal axis.

3. The fluid material dispensing system of claim 2, wherein the first and second oblique axes are each angled towards the longitudinal axis as the first and second oblique axes extend towards the at least one hole.

4. The fluid material dispensing system of claim 2, wherein the portion of the first passage extends from the at least one hole towards the first pump outlet along the first oblique axis, and the portion of the second passage extends from the at least one hole towards the second pump outlet along the second oblique axis.

5. The fluid material dispensing system of claim 2, wherein the first oblique axis does not intersect the housing as the first oblique axis extends away from the first passage through the at least one hole, and the second oblique axis does not intersect the housing as the second oblique axis extends away from the second passage through the at least one hole.

6. The fluid material dispensing system of claim 1, wherein the housing comprises at least one inner surface that at least partially defines the at least one hole, the at least one inner surface defining a first opening to the first passage and a second opening to the second passage, the at least one inner surface extending along a direction that is oblique relative to a longitudinal direction.

7. The fluid material dispensing system of claim 6, wherein the at least one inner surface comprises a first inner surface portion that defines the first opening and a second inner surface portion that defines the second opening, wherein the first and second inner surface portions diverge from one another as they extend away from the first and second pumps.

8. The fluid material dispensing system of claim 1, comprising a fastener that is configured to move the engagement feature of at least one of the housing and the fluid dispenser between 1) a locked position, wherein the engagement features engage one another with sufficient engagement force so as to prevent the plug from being removed from the receptacle, and 2) an unlocked position, wherein the engagement force is reduced so as to permit the plug to be removed from the receptacle.

9. The fluid material dispensing system of claim 1, wherein the engagement feature is a recess and the corresponding engagement feature is a protrusion.

10. A fluid dispenser for a material dispensing system, the fluid dispenser comprising:
a dispensing body having a first end and a second end that are offset from one another, the second end comprising at least one nozzle configured to dispense first and second fluid materials;
a plug attached to the first end of the dispensing body and configured to be received in a receptacle of a housing that supports first and second pumps of the fluid material dispensing system, the plug comprising:
at least one outer surface that defines first and second openings; and
at least one projection that extends from the at least one outer surface, the projection configured to be received in a hole of the receptacle and defining an engagement feature that is configured to engage a corresponding engagement feature of the housing,
wherein the fluid dispenser defines 1) a first fluid passage that extends from the first opening towards the at least one nozzle, the first fluid passage being configured to direct a first fluid material from the first pump towards the at least one nozzle, and 2) a second fluid passage that extends from the second opening towards the at least one nozzle, the second fluid passage being configured to direct a second fluid material from the second pump towards the at least one nozzle.

11. The fluid dispenser of claim 10, wherein the dispensing body defines a mixer that comprises a mixing chamber configured to mix the first and second fluid materials into a mixture, the first and second fluid passages extend from the first and second openings, respectively, to the mixing chamber, and the mixing chamber is configured to direct the mixture to the nozzle.

12. The fluid dispenser of claim 10, wherein the dispensing body defines a non-mixing dispenser, the first passage extends from the first opening towards a first nozzle of the least one nozzle such that the first passage is configured to direct a first fluid material to the first nozzle, and the second passage extends from the second opening towards a second nozzle of the at least one nozzle such that the second passage is configured to direct a second fluid material to the second nozzle.

13. The fluid dispenser of claim 10, wherein at least a portion of the first passage extends along a first oblique axis that is oblique relative to a central axis of the fluid dispenser, and at least a portion of the second passage extends along a second oblique axis that is oblique relative to the central axis.

14. The fluid dispenser of claim 13, wherein the first and second oblique axes are angled away from the central axis as the first and second oblique axes extend toward the second end.

15. The fluid dispenser of claim 13, wherein the portion of the first passage that extends along the first oblique axis extends from the at least one outer surface, and the portion of the second passage that extends along the second oblique axis extends from the at least one outer surface.

16. The fluid dispenser of claim 10, wherein the at least one outer surface includes first and second surface portions that are angled away from a central axis of the fluid dispenser as the first and second surface portions extend toward the second end, the first and second surface portions defining the first and second openings, respectively.

17. The fluid dispenser of claim 16, wherein the first and second surface portions diverge away from one another as they extend towards the second end.

18. A method of assembling a fluid material dispensing system, the method comprising:
aligning a plug of a fluid dispenser with a receptacle of a housing, the housing configured to support first and second pumps of the fluid material dispensing system,
inserting the plug in the receptacle such that first and second fluid passages of the fluid dispenser are in fluid communication with first and second fluid passages of the housing, respectively, and such that 1) the first fluid passages of the fluid dispenser and the housing are in fluid communication with one another and configured to direct a first fluid material from the first pump to at least one nozzle of the fluid dispenser, and 2) the second fluid passages of the fluid dispenser and the housing are in fluid communication with one another and configured to direct a second fluid material from the second pump to the at least one nozzle; and
actuating a fastener so as to move an engagement feature of at least one of the fluid dispenser and the housing into engagement with an engagement feature of the other of the at least one of the fluid dispenser and the housing so as to releasably secure the fluid dispenser to the housing.

19. The method of claim 18, wherein the inserting step comprises mating a first inner surface portion of the housing with a first outer surface portion of the fluid dispenser, and mating a second inner surface portion of the housing with a second outer surface portion of the fluid dispenser, wherein the first and second inner surfaces of the housing diverge away from one another along a distal direction and the first and second inner surfaces of the fluid dispenser converge towards one another along the distal direction.

20. The method of claim 18, wherein the inserting step comprises inserting the plug into a hole defined by the receptacle that extends into the housing, and the actuating step comprises causing the engagement feature of the fastener to move within the hole so as to engage the engagement feature of the plug within the hole.
